(19) United States
(12) Patent Application Publication
(10) Pub. No.: US 2025/0278966 A1
(43) Pub. Date: Sep. 4, 2025

(54) Safe door opening technology based on radar and UWB sensing

(71) Applicant: XTHINGS INDUSTRY LLC, Fremont, CA (US)

(72) Inventor: Lingling Qian, Fremont, CA (US)

(73) Assignee: XTHINGS INDUSTRY LLC, Fremont, CA (US)

(21) Appl. No.: 19/209,904

(22) Filed: May 16, 2025

(51) Int. Cl. G07C 9/00; H01Q 5/25; H01Q 21/28

(52) U.S. Cl. CPC G07C 9/00309; H01Q 5/25; H01Q 21/28; G07C 2009/00333

(57) ABSTRACT

A safe door opening technology based on radar and UWB sensing, comprising a first Bluetooth arranged on a front lock body, wherein a first UWB antenna and a second UWB antenna are symmetrically arranged in middle portions of the front lock body, a radar is arranged on the front lock body and below an NFC antenna, and a second Bluetooth corresponding to the position of the first Bluetooth is arranged on the rear lock body. The present invention adds the radar to the front lock body to detect the outside of a door, and can determine whether a terminal (mobile phone) used by a user is inside or outside the door, which avoids the problem of difficulty in distinguishing inside and outside the door caused by only Bluetooth connection in the prior art, and further makes the setting of sensing and unlocking distances respectively as the terminal approaches.

### TECHNICAL FIELD

The present invention relates to the field of smart lock technology, and more specifically to a safe door opening technology based on radar and UWB sensing.

### BACKGROUND TECHNOLOGY

In the field of smart door locks, wireless communication is one of its basic functions. The hardware basis of this technology is to set wireless communication and sensing devices on the front and rear lock bodies of existing smart door locks respectively. These devices use the combination of existing terminals and wireless technologies to adapt to and meet people's communication, unlocking and locking functions of smart door locks and users' operating habits.

In the prior art, when Bluetooth technology is used to approach a door, the distance measurement is basically carried out by using a single Bluetooth antenna. Due to installation and use requirements, a Bluetooth chip will be placed on a rear lock body inside the door. In this way, when a Bluetooth signal is diffracted through the door or wall to the outside of the door, the signal will be weakened, which will cause great interference to the distance measurement, and the single Bluetooth antenna cannot distinguish between inside and outside the door, which will cause the door to open unresponsive, or even open/lock the door by mistake.

Based on the above reasons, the present invention designs a safe door opening technology based on radar and UWB sensing, which can accurately identify the inside and outside of the door, and is not affected by the weakening of the Bluetooth signal. At the same time, the distance measurement is accurate, which improves the safety and stability of wireless smart unlocking.

### SUMMARY OF THE INVENTION

The purpose of the present invention is to overcome the shortcomings of the prior art and provide a safe door opening technology based on radar and UWB sensing, which can accurately identify the inside and outside of the door and is not affected by the weakening of the Bluetooth signal. At the same time, the distance measurement is accurate, which improves the safety and stability of wireless intelligent unlocking.

In order to achieve the above purpose, the present invention provides a safe door opening technology based on radar and UWB sensing, comprising a front lock body, a rear lock body, a first Bluetooth, a second Bluetooth, an NFC antenna, a radar, a first UWB antenna and a second UWB antenna, wherein the first Bluetooth is arranged on the front lock body, the first UWB antenna and the second UWB antenna are symmetrically arranged in middle portions of the front lock body, the radar is arranged on the front lock body and below an NFC antenna, and on the rear lock body is provided with the second Bluetooth which corresponds to the first Bluetooth in position; and
the first Bluetooth and the second Bluetooth form connection ranges respectively outside and inside a door; the radar forms a scanning range at a fixed angle outside the door for judging whether a communication terminal is outside the door; the first UWB antenna forms a sensing range of 2 m at a fixed angle outside the door, and the second UWB antenna forms an unlocking range of 1 m at a fixed angle outside the door.

The NFC antenna is arranged on an outer circumference of the first UWB antenna and the second UWB antenna.

The radar detects outside the door at an angle of 90 to 150 degrees.

The first UWB antenna detects outside the door at an angle of 60 to 90 degrees.

The second UWB antenna detects outside the door at an angle of 30 to 60 degrees.

A connection range of the first Bluetooth and the second Bluetooth is from 3 m to 5 m.

The first Bluetooth and second Bluetooth together form a full-angle circular connection range.

A scanning range of the radar is from 3 m to 5 m.

Compared with the prior art, the present invention adds the radar to the front lock body to detect the outside of the door, which can determine whether terminals (mobile phone) used by users are inside or outside the door, avoiding the problem of difficulty in distinguishing inside and outside the door caused by only Bluetooth connection in the prior art, and further makes the setting of sensing and unlocking distances as the terminals approach, further improving the function of stable and safe unlocking. The dual Bluetooth setup forms a stable and non-attenuated configuration range inside and outside the door to ensure stable communication.

### BRIEF DESCRIPTION OF THE DRAWINGS

FIG. 1 is a schematic diagram of an antenna layout on a front lock body of the present invention.

FIG. 2 is a schematic diagram of a Bluetooth layout on a rear lock body of the present invention.

The markups in the drawings are indicated as follows:
1—front lock body;
2—first Bluetooth;
3—first UWB antenna;
4—radar;
5—second UWB antenna;
6—NFC antenna;
7—second Bluetooth; and
8—rear lock body.

### SPECIFIC EMBODIMENTS

The present invention is further described in combination with the attached drawings.

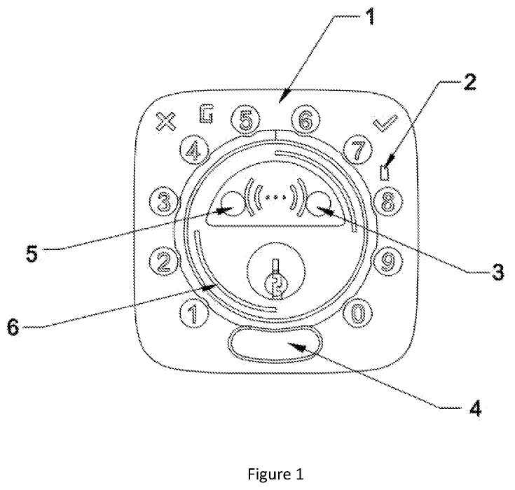

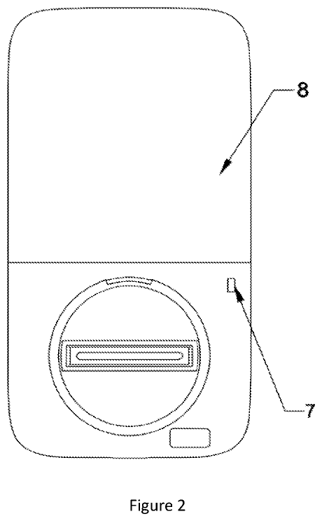

Please refer to FIGS. 1-2, the present invention provides a safe door opening technology based on radar and UWB sensing, comprising a front lock body 1, a rear lock body 8, a first Bluetooth 2, a second Bluetooth 7, an NFC antenna 6, a radar 4, a first UWB antenna 3 and a second UWB antenna 5, wherein the first Bluetooth 2 is arranged on the front lock body 1, the first UWB antenna 3 and the second UWB antenna 5 are symmetrically arranged in middle portions of the front lock body (1), the radar 4 is arranged on the front lock body 1 and below an NFC antenna 6, and on the rear lock body 8 is provided with the second Bluetooth 7 which corresponds to the first Bluetooth 2 in position; and
the first Bluetooth 2 and the second Bluetooth 7 form connection ranges respectively outside and inside a door; the radar 4 forms a scanning range at a fixed angle outside the door for judging whether a communication terminal is outside the door; the first UWB antenna 3 forms a sensing range of 2 m at a fixed angle outside the door, and the second UWB antenna 5 forms an unlocking range of 1 m at a fixed angle outside the door.

The NFC antenna 6 is arranged on an outer circumference of the first UWB antenna 3 and the second UWB antenna 5.

The radar 4 detects outside the door at an angle of 90 to 150 degrees.

The first UWB antenna 3 detects outside the door at an angle of 60 to 90 degrees.

The second UWB antenna 5 detects outside the door at an angle of 30 to 60 degrees.

A connection range of the first Bluetooth 2 and the second Bluetooth 7 is from 3 m to 5 m.

The first Bluetooth 2 and second Bluetooth 7 together form a full-angle circular connection range.

A scanning range of the radar 4 is from 3 m to 5 m.

The above are merely preferred embodiments of the present invention, which are only used to help understand the method and core idea of the present application. The protection scope of the present invention is not limited to the above embodiments. Any technical solution under the idea of the present invention falls within the protection scope of the present invention. It should be pointed out that for those skilled in the art, certain improvements and embellishments made without departing from the principle of the present invention should also be regarded as within the protection scope of the present invention.

The present invention solves the problems in the prior art that when the smart lock uses Bluetooth to open the door, the instability caused by the attenuation of the Bluetooth signal leads to unlocking difficulties, the inability to determine whether the door is inside or outside, and the wrong unlocking. A stable Bluetooth configuration range is set through dual Bluetooth settings, and the outside door radar sensing is used to judge the inside and outside of the door. The multi-level sensing and unlocking range is performed through dual UWB antennas, which greatly improves the stability and reliability of the communication between the terminal and the smart lock, making the unlocking safer, more accurate and faster.

1. A safe door opening technology based on radar and UWB sensing, comprising a front lock body (1), a rear lock body (8), a first Bluetooth (2), a second Bluetooth (7), an NFC antenna (6), a radar (4), a first UWB antenna (3) and a second UWB antenna (5), wherein the first Bluetooth (2) is arranged on the front lock body (1), the first UWB antenna (3) and the second UWB antenna (5) are symmetrically arranged in middle portions of the front lock body (1), the radar (4) is arranged on the front lock body (1) and below an NFC antenna (6), and on the rear lock body (8) is provided with the second Bluetooth (7) which corresponds to the first Bluetooth (2) in position; and
the first Bluetooth (2) and the second Bluetooth (7) form connection ranges respectively outside and inside a door; the radar (4) forms a scanning range at a fixed angle outside the door for judging whether a communication terminal is outside the door; the first UWB antenna (3) forms a sensing range of 2 m at a fixed angle outside the door, and the second UWB antenna (5) forms an unlocking range of 1 m at a fixed angle outside the door.

2. The safe door opening technology based on radar and UWB sensing according to claim 1, wherein the NFC antenna (6) is arranged on an outer circumference of the first UWB antenna (3) and the second UWB antenna (5).

3. The safe door opening technology based on radar and UWB sensing according to claim 1, wherein the radar (4) detects outside the door at an angle of 90 to 150 degrees.

4. The safe door opening technology based on radar and UWB sensing according to claim 1, wherein the first UWB antenna (3) detects outside the door at an angle of 60 to 90 degrees.

5. The safe door opening technology based on radar and UWB sensing according to claim 1, wherein the second UWB antenna (5) detects outside the door at an angle of 30 to 60 degrees.

6. The safe door opening technology based on radar and UWB sensing according to claim 1, wherein a connection range of the first Bluetooth (2) and the second Bluetooth (7) is from 3 m to 5 m.

7. The safe door opening technology based on radar and UWB sensing according to claim 6, wherein the first Bluetooth (2) and second Bluetooth (7) together form a full-angle circular connection range.

8. The safe door opening technology based on radar and UWB sensing according to claim 1, wherein a scanning range of the radar (4) is from 3 m to 5 m.
